(19) United States
(12) Patent Application Publication
(10) Pub. No.: US 2009/0149547 A1
(43) Pub. Date: Jun. 11, 2009

(54) VIRUCIDAL DISINFECTANT FOR AVIAN INFLUENZA VIRUS

(75) Inventors: Reiji SEKI, Saitama (JP); Ryoji KAMIMURA, Tokyo (JP)

Correspondence Address: DENNIS G. LAPOINTE;LAPOINTE LAW GROUP, PL, PO BOX 1294, TARPON SPRINGS, FL, 34688-1294, US

(73) Assignee: TAMURA SEIYAKU KABUSHIKI KAISHA, Tokyo (JP)

(21) Appl. No.: 12/262,371

(22) Filed: Oct. 31, 2008

Related U.S. Application Data
(63) Continuation-in-part of application No. 11/953,903, filed on Dec. 11, 2007.

(51) Int. Cl. A01N 33/12; A01P 1/00

(52) U.S. Cl. 514/642

(57) ABSTRACT

A novel virucidal disinfectant for avian influenza virus is provided. A virucidal disinfectant for avian influenza virus characterized by containing as essential constituents
(A) dialkyldimethylammonium chloride represented by the formula:

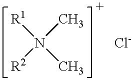

wherein both R¹ and R² are alkyl groups and may be the same or different,
(B) a halogenated phenol based compound represented by the formula:

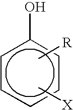

wherein R is an alkyl or aryl group, and X is a halogen element, and
(C) o-dichlorobenzene.

### RELATED APPLICATIONS

This application is a continuation-in-part of U.S. patent application Ser. No. 11/953,903 filed Dec. 11, 2007.

### FIELD OF THE INVENTION

The present invention relates to a virucidal disinfectant for avian influenza virus.

### BACKGROUND OF THE INVENTION

Currently, as general disinfection effect tests for bacteria and the like, an experiment at an ambient temperature or a room temperature as a reaction temperature has been performed in addition to tests under predetermined conditions of water quality, reaction time and the like. The ambient temperature or the room temperature is a reactive temperature at 20 to 28° C. and 25° C. on average.

However, in actual uses in a field, the conditions are complicated due to the presence of organic materials such as feces and urine and blood, and low reaction temperature. Meanwhile, the higher the reaction temperature is, the higher the disinfection effect. Conversely, the lower the temperature is, the lower the effect. In particular, in the case of avian influenza virus targeted for the present invention, in use in a cold season when avian influenza easily occurs and prevails, it is thought that sensitivity of the disinfectant itself to the condition of low temperature becomes a large factor.

Concerning the disinfectant for animals using didecyldimethylammonium chloride as a main agent widely used at present as a measure for avian influenza virus, it has also been reported that its disinfection effect is remarkably attenuated at low temperature and in the presence of organic materials.

Avian influenza virus (AIV) is an RNA virus having an envelope, and thought to be a virus capable of being easily disinfected by various virucidal disinfectants and chemicals. Thus, the disinfection effect on avian influenza has not been frequently published. Among the papers for avian influenza submitted and published totaling 102 volumes from Vol. 1 in 1984 to Vol. 2 in 2008 by AVIAN DISEASES (publisher: American Association of Avian Pathologists, Inc.) regarded as the most authoritative avian disease journal, five papers for the disinfection of AIV have been found and are shown in Table 1.

TABLE 1

| Article | | | | | | | |
|---|---|---|---|---|---|---|---|
| published | | | Tested | | Reaction | Reaction | |
| year | Article title | Main author | virus | Disinfectants | temperature | time | |
| 1999 | Evaluation of Disinfectants with the addition | Davison. S | H7N2 | Phenol agent | Room | 10 | min |
| | of Antifreezing Compounds against | | | 4Q agent | temperature | | |
| | Nonpathogenic H7N2 Avian Influenza Virus | | | Formalin | | | |
| | Vol 43 No2 533·537 | | | | | | |
| 2003 | Survival of Avian Influenza Virus H7N2 in | Lu. H | H7N2 | 4Q + Formalin | Room | 5, 10, 15, 20 | min |
| | SPF Chickens and their Environment | | | | temperature | | |
| | Vol 47, SPECIAL ISSUE 1015-1027 | | | | | | |
| 2003 | The effect of various Disinfectants on | Suarez. D. L | H5N9, | Phenol agent | Room | 10, 60 | min |
| | detection of Avian Influenza Virus by Real | | H7N3 | 4Q agent | temperature | | |
| | Time RT-PCR | | | | | | |
| | Vol 47, SPECIAL ISSUE 1091-1095 | | | | | | |
| 2008 | Inactivation of Avian Influenza Virus using | Lombardi, M. L | H7N2 | acetic acid citric | Room | 3-5 | min |
| | Common Detergents and Chemicals | | | acid hypochlorite, | temperature | | |
| | Vol 52 No1 118-123 | | | the others | | | |
| 2008 | Efficacy of Disinfectants and Hand Sanitizers | Patnayak. D. P | H13N7 | Phenol agent | Room | 1, 3, 5, 10 | min |
| | against Avian Respiratory Viruses | | | 4Q agent | temperature | | |
| | Vol 52 No2 199-202 | | | Glutaraldehyde | | | |
| | | | | agent | | | |

The room temperature (reactive temperature) usually refers to 20 to 28° C. or around 25° C.

Concerning the reactive temperature which is a factor which largely affects the disinfection of AIV, in the above five papers in Table 1, the experiments were performed at an ambient temperature or room temperature which is a conventional experimental condition, and no experiment exhibiting the disinfection effect at a low temperature from 0 to 5° C. was performed as shown in Table 4. Here, a major outbreak of avian influenza (H5N2 subtype) in Pennsylvania in the US in 1983 to 1984 which allowed recognition as to the scale of effect of avian influenza on avian industries occurred after autumn in a cold low temperature season. Occurrence and prevalence of a new type highly pathogenic avian influenza which originated with the AIV H5N1 subtype in Hong Kong in 1996, the infection passing from birds to human beings and widely propagated as an emerging virus from Southeast Asia to the Middle East, Africa and Europe have been almost limited to cold low temperature seasons such as late autumn, winter and spring. That is, it can be said that avian influenza easily occurs and prevails in cold low temperature seasons.

As a result of surveys and studies up until now, AIV itself is retained and present in water at ultralow temperatures in lakes in the Arctic Circle. It is believed that AIV infects wild birds, is carried from the north to the south by migration of the infected birds and infects circularly between indigenous birds and farmed water birds.

Table 2 shows experimental results for virus inactivation at different temperatures when the infectiveness of AIV was inactivated, described in Lu. H, “Survival of Avian Influenza Virus H7N2 in SPF Chickens and their environment,” AVIAN DISEASES, Vol. 47: 1015-1021, 2003 among the five papers shown in Table 1. In this experiment, chicken feces were added and its effect on the disinfection was examined in order to reveal the disinfection effect in the presence of organic materials in consideration of a field condition in addition to the reaction temperature.

TABLE 2

| | | | | Field | |
|---|---|---|---|---|---|
| | Inactivation | SPF chicken | Experiment field | commercial | |
| Temperature | status | feces^{A} | chicken feces^{B} | chicken feces^{C} | Allantoic Fluids |
| 56° C. | Inactivated | 30 min^{D} | 20 min | 15 min | 90 min |
| (water bath) | Not inactivated | 20 min | 10 min | 10 min | 60 min |
| 37° C. | Inactivated | 16 days | 36 hr | 24 hr | 12 days |
| (water bath) | Not inactivated | 14 days | 12 hr | 8 hr | 8 days |
| 28-30° C. | Inactivated | ND | 36 hr | 12 hr | 20 days |
| (incubator) | Not inactivated | ND | 12 hr | 8 hr | 19 days |
| 15-20° C. | Inactivated | 23 days | 6 days | ND | 32 days |
| (ambient) | Not inactivated | 19 days | 4 days | >2 days | 31 days |
| 4° C. | Inactivated | ND | ND | ND | ND |
| (refrigerator) | Not inactivated | >23 days | >20 days | >20 days | >8 months |

^{A}The SPF chicken feces were collected from SPF chickens housed in a BSL-2 biocontainment facility.
^{B}The experimental field chicken feces were collected from experimental field chickens removed from a field farm and housed in a BSL-2 biocontainment facility.
^{C}Commercial chicken feces were collected from commercial chickens in a field house.
^{D}ND = not done.

As shown in Table 2, under the condition of a low temperature at 4° C., the activity of AIV was not lost in any condition and its infectiveness was kept for a long time.

Therefore, avian influenza is characterized by its ease in occurrence and prevalence in cold low temperature seasons and not losing its activity and keeping its infectiveness under a low temperature condition. Thus, in the disinfection of AIV, the reactive temperature is important among concentration, reactive temperature and duration of action which are referred to as the three principles of disinfection.

Thus, conventionally in the disinfection of AIV under a low temperature condition, in order to make the reactive temperature close to the ambient temperature or room temperature, it is recommended to raise the temperature of a diluting solution for the virucidal disinfectant to perform spraying or scattering.

However, even if the temperature of the liquid disinfectant is effectively kept for virucide of AIV before spraying, the liquid temperature is rapidly lowered at the moment of spraying in typical spraying in a field in winter where the temperature condition is severe. The reactive temperature when the disinfectant contacts the virus is remarkably lowered. Thus, a sufficient disinfection effect cannot be exerted.

Therefore, in the disinfection of AIV, it has been necessary to enhance the sensitivity of the disinfectant at low temperatures so that the disinfection effect can be exerted even under a low temperature condition.

In such a context, the present applicant has found that a prophylactic disinfectant for animal coccidium disease caused by a protozoan enterozoa belonging to the genus Eimeria according to Patent Document 1 owned by the present applicant has an exceptional virucidal effect on avian influenza virus under a low temperature condition compared with the virucidal disinfectants having been developed up until now.

[Patent Document 1]: Japanese Patent No. 2598774

### SUMMARY OF THE INVENTION

The present invention relates to a novel virucidal disinfectant for avian influenza virus.

The first invention of the present invention relates to a virucidal disinfectant for avian influenza virus characterized by containing as essential constituents
(A) dialkyldimethylammonium chloride represented by the formula (I):

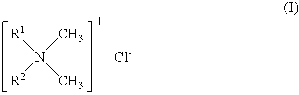

wherein both R¹ and R² are alkyl groups and may be the same or different,
(B) a halogenated phenol based compound represented by the formula (II):

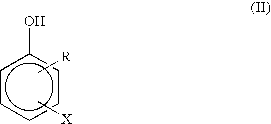

wherein R is an alkyl or aryl group, and X is a halogen element, and
(C) o-dichlorobenzene.

The second invention of the present invention relates to the virucidal disinfectant for avian influenza virus according to claim 1 wherein dialkyldimethylammonium chloride is didecyldimethylammonium chloride.

The alkyl group in the formula (I) used in the present invention may be straight or branched, and is not particularly limited, but is preferably the alkyl group having 8 to 16 carbon atoms, e.g., a normal or iso type of octyl, nonyl, decyl, undecyl, dodecyl, tridecyl, tetradecyl, pentadecyl, or hexadecyl.

As the halogenated phenol based compound represented by the formula (II) used in the present invention, those in which phenol at any position (o-, m- or p-position) has been substituted with halogen, alkyl or aryl can be used. The alkyl group is not particularly limited, but is preferably a lower alkyl group ordinarily having 1 to 4 carbon atoms. The aryl group can include phenyl having substituents sometimes (e.g., phenyl, xylyl), diphenyl and naphthyl. Halogen can include chlorine and bromine. One example of this compound includes 4-chloro-3-methylphenol (p-chloro-m-cresol) or chloro-o-phenylphenol.

A mixed ratio of the above (A), (B) and (C) in the present invention is not particularly limited, but typically the ratio of (A) about 8 to 20% by weight, (B) about 1 to 10% by weight and (C) about 55 to 75% by weight based on the total preparation constituents is employed.

The virucidal disinfectant for avian influenza virus of the present invention using these constituents as the essential constituents can be used in various formulations, but it is most preferably used in the form of an emulsion. When this is used as the emulsion, a surfactant optimum in obtaining stable emulsification in water is added, and if necessary, dissolution aids, permeation aids and stabilizers can be combined.

(1) It has been discovered that the prophylactic oocystcidal disinfectant for the coccidium disease according to Pat. No. 2,598,774 is effective for avian influenza virus.

(2) The combination of (A), (B) and (C) has a higher virucidal effect at low temperature and in the presence of organic materials compared with the use of didecyldimethylammonium chloride (A) alone.

### DESCRIPTION OF THE PREFERRED EMBODIMENTS

The present invention will be described with reference to Examples, but the present invention is not limited thereto.

Concerning the disinfectant of the present invention composed of (A), (B) and (C) and the disinfectant substantially composed of (A) alone (product of the present applicant and product K of another company), a virucidal effect on avian influenza virus was examined. In the test, assuming a use condition in a field, the effect of organic materials addition, the effect after freezing and thawing, and the effect at low temperature were examined.

Types and concentrations of chemicals used are as follows:

### (1) EXAMPLE 1

| | | |
|---|---|---|
| (A) Didecyldimethylammonium chloride (80% by weight) | 15 | g |
| (B) Chlorocresol | 5 | g |
| (C) o-Dichlorobenzene | 70 | g |
| (D) Emulsifier (polyoxyethylene castor oil) | 10 | g |
| Total | 100 | mL |

### (2) COMPARATIVE EXAMPLE 1

| | | |
|---|---|---|
| (A) Didecyldimethylammonium chloride (80% by weight) | 12.5 | g |
| (E) Viscosity lowering agent (isopropyl alcohol) | 8.0 | g |
| (F) Others | | |
| Total | 100 | mL |

### (3) COMPARATIVE EXAMPLE 2

| | |
|---|---|
| Product K from another company, containing 10 g of | 100 mL |
| didecyldimethylammonium chloride | |

Test method

### [Virus Used]

Attenuated avian influenza virus R (A/duck/Mongolia/54/01-A/duck/Mongolia/47/01) (H5N1) strain. The virus was inoculated to embryonated chicken eggs, and a chorioallantoic liquid was collected to be subjected to the test. A virus titer (EID₅₀) was measured using the embryonated chicken eggs.

### [Organic Materials]

Feces of chickens bred in animal facility at the Graduate School of Veterinary Medicine, Hokkaido University were collected and used for the test.

### [Test for Effect of Disinfectant in the Presence of Organic Materials]

The disinfectant was diluted with PBS (abbreviation of phosphate buffered solution, obtained from sodium dihydrogen phosphate and disodium hydrogen phosphate). A viral solution and the chicken feces were diluted with PBS. All the diluted solutions were stored in ice until use. 0.25 mL of the viral solution diluted at 10⁷ EID₅₀ was first mixed with an equal volume of the chicken feces solution. Subsequently, 0.5 mL of this mixture was mixed with an equal volume of the diluted disinfectant solution. This mixed solution (1 mL) was reacted in an incubator at 25° C. for 10 minutes. The resulting reaction solution (each 0.1 mL) was inoculated to three 10 days embryonic hatching eggs. After incubating at 35° C. for 48 hours, an HA titer in the chorioallantoic liquid was measured. A maximum dilution ratio of the disinfectant effective for the virucidal effect was calculated from the dilution ratio of the disinfectant at which no viral growth was observed in all three eggs (HA titer is an indicator for viral survival).

The virus related to the present invention is the avian influenza virus belonging to Paramyxovirinae.

The results are shown in the following table.

TABLE 3

| | Maximum dilution ratio of | | | |
|---|---|---|---|---|
| | disinfectant effective for AIV (1:n) | | | |
| | No | Addition | Addition of | Addition of |
| | organic | of 0.25% | 1.25% chicken | 5% chicken |
| Disinfectant | materialsr | chicken feces | feces | faces |
| Comparative | 3200 | 3200 | 1600 | 500 |
| Example 1 | | | | |
| Example 1 | 6400 | 3200 | 3200 | 800 |
| Comparative | 3200 | 3200 | 1600 | 400 |
| Example 2 | | | | |

(Note: AIV is an abbreviation of Avian Influenza Virus.)

When reacted at 25° C. for 10 minutes in the absence of the organic materials, the effective maximum dilution ratio of each disinfectant was 3200 times in Comparative Example 1, 6400 times in Example 1, or 3200 times in Comparative Example 2.

The effect of each disinfectant in the presence of the organic materials was attenuated in proportion to the concentration of the organic materials.

### [Test for Effect of Repeatedly Frozen and Thawed Disinfectant]

The disinfectant was diluted with PBS. The diluted disinfectant was repeatedly frozen and thawed 5 times, and then subjected to the test. The viral solution was all diluted with PBS. All the diluted solutions were stored in ice until use. 0.25 mL of the viral solution diluted at 10⁷ EID₅₀ was first mixed with an equal volume of PBS. Subsequently, 0.5 mL of this mixture was mixed with an equal volume of the diluted disinfectant solution. This mixed solution (1 mL) was reacted in the incubator at 25° C. for 10 minutes. The resulting reaction solution (each 0.1 mL) was inoculated to three 10 days embryonic hatching eggs. After incubating at 35° C. for 48 hours, the HA titer in the chorioallantoic liquid was measured. The maximum dilution ratio of the disinfectant effective for the virucidal effect was calculated from the dilution ratio of the disinfectant at which no viral growth was observed in all three eggs.

The results are shown in the following table.

TABLE 4

Maximum dilution ratio of
disinfectant effective for AIV (1:n)

| Disinfectant | No freezing/thawing | 5 times freezing/thawing |
|---|---|---|
| Comparative | 3200 | 3200 |
| Example 1 | | |
| Example 1 | 6400 | 3200 |
| Comparative | 3200 | 1600 |
| Example 2 | | |

(Note: AIV is an abbreviation of Avian Influenza Virus.)

It was found that repeated freezing and thawing did not affect the disinfection effect.

### [Test for Effect of Disinfectant at Low Temperature]

The disinfectant was diluted with PBS. The viral solution was all diluted with PBS. All the diluted solutions were stored in ice until use. 0.25 mL of the viral solution diluted at 10⁷ EID₅₀ was first mixed with an equal volume of PBS. Subsequently, 0.5 mL of this mixture was mixed with an equal volume of the diluted disinfectant solution. This mixed solution (1 mL) was reacted in the incubator at 5° C. for 10 minutes. The resulting reaction solution (each 0.1 mL) was inoculated to three 10 days embryonic hatching eggs. After incubating at 35° C. for 48 hours, the HA titer in the chorioallantoic liquid was measured. The maximum dilution ratio of the disinfectant effective for the virucidal effect was calculated from the dilution ratio of the disinfectant at which no viral growth was observed in all three eggs.

The results are shown in the following table.

TABLE 5

Maximum dilution ratio of
disinfectant effective for AIV (1:n)

| Disinfectant | Act at 25° C. | Act at 5° C. |
|---|---|---|
| Comparative | 3200 | 200 |
| Example 1 | | |
| Example 1 | 6400 | 1600 |
| Comparative | 3200 | 200 |
| Example 2 | | |

(Note: AIV is an abbreviation of Avian Influenza Virus.)

The conventional disinfectants in Comparative Examples 1 and 2 are hard to exert a disinfection effect when the reactive temperature is lower than the experimental temperature, i.e., the ambient temperature or room temperature, and in particular, cannot exert the disinfection effect on the avian influenza virus unless it is used at a relatively lowly diluted high concentration at 5° C. assumed to be the low temperature cold season as shown in Table 5.

On the contrary, in the virucidal disinfectant for the avian influenza virus in Example 1, as shown in Table 5, a maximum effective dilution ratio for the H5N1 subtype avian influenza virus is 1,600 times under the low temperature condition even if the reactive temperature is 5° C. (0 to 5° C.). That is, the virucidal disinfectant in Example 1 can sufficiently exert the disinfection effect on the avian influenza virus even under the low temperature condition and can be used at a relatively highly diluted low concentration. That is, the virucidal disinfectant for avian influenza in Example 1 is very good in sensitivity at low temperatures because the maximum effective dilution ratio in Comparative Examples 1 and 2 is 200 times, compared with the disinfectants composed mainly of cationic surfactants frequently used in veterinary fields worldwide.

Therefore, the virucidal disinfectant for avian influenza in the present Example is suitable for the disinfection of the avian influenza virus because this disinfectant can sufficiently exert the disinfection effect even under low temperature conditions in the cold low temperature seasons from autumn to spring when avian influenza easily occurs and prevails.

This disinfectant is not required to be strictly considered or handled at its reactive temperature even in low temperature cold seasons, and can be easily used by ordinary disinfection techniques such as spraying and scattering.

### Discussion

When the virucidal effect of Example 1 and Comparative Example 1 on the avian influenza virus was examined, assuming a use condition in a field, the effect of organic materials addition, the effect after freezing and thawing, and the effect at low temperature were examined respectively. Although the disinfection effect is attenuated by the addition of organic materials, all the disinfectants showed a sufficient disinfection effect. In the test at low temperature, the disinfection effect of Comparative Example 1 containing didecyldimethylammonium chloride as the major constituents was remarkably attenuated. Conversely, Example 1 of the present invention exhibited a sufficient effect even at low temperature. The freezing and thawing did not affect the disinfection effect.

From the above, it was found that the disinfectants subjected to these tests could inactivate the avian influenza virus by use at an appropriate concentration depending on the intended use.

What is claimed is:

1. A virucidal disinfectant for avian influenza virus characterized by containing as essential constituents
(A) dialkyldimethylammonium chloride represented by the formula: 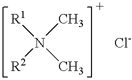
wherein both R¹ and R² are alkyl groups and may be the same or different,
(B) a halogenated phenol based compound represented by the formula: 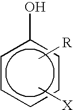
wherein R is an alkyl or aryl group, and X is a halogen element, and
(C) o-dichlorobenzene.

2. The virucidal disinfectant for avian influenza virus according to claim 1 wherein dialkyldimethylammonium chloride is didecyldimethylammonium chloride.
